(19) United States
(12) Patent Application Publication
(10) Pub. No.: US 2004/0190871 A1
(43) Pub. Date: Sep. 30, 2004

(54) Recording medium having data structure for managing reproduction of multiple reproduction path video data recorded thereon and recording and reproducing methods and apparatuses

(76) Inventors: Kang Soo Seo, Anyang (KR); Byung Jin Kim, Sungnam (KR); Hyung Sun Kim, Seoul (KR); Mi Hyun Kim, Seoul (KR)

Correspondence Address: HARNESS, DICKEY & PIERCE, P.L.C., P.O. BOX 8910, RESTON, VA, 20195, US

(21) Appl. No.: 10/807,120

(22) Filed: Mar. 24, 2004

(30) Foreign Application Priority Data
Mar. 26, 2003 (KR) 10-2003-0018941

(51) Int. Cl. H04N 5/781

(52) U.S. Cl. 386/95; 386/125

(57) ABSTRACT

The present invention relates to a recording medium having a data structure for managing reproduction of at least video data having multiple reproduction paths recorded thereon as well as methods and apparatuses for reproduction and recording the data structure. In the present invention, reproduction paths, e.g., parental levels of multi-path video data are identified individually by playlists or playitems included in a playlist.

### FOREIGN PRIORITY

The present invention claims priority under 35 U.S.C. 119 on Korean Application No. 10-2003-018941 filed Mar. 26, 2003; the contents of which are incorporated by reference in their entirety.

### BACKGROUND OF THE INVENTION

1. Field of the Invention

The present invention relates to a recording medium having a data structure for managing reproduction of at least video data having multiple reproduction paths recorded thereon as well as methods and apparatuses for reproduction and recording the data structure.

2. Description of the Related Art

The standardization of new high-density read only and rewritable optical disks capable of recording large amounts of high-quality video and audio data has been progressing rapidly and new optical disk related products are expected to be commercially available on the market in the near future. The Blu-ray Disc Rewritable (BD-RE) is one example of these new optical disks.

FIG. 1 illustrates the file structure of the BD-RE. The file structure or data structure provides for managing the reproduction of the video and audio data recorded on the BD-RE. As shown, the data structure includes a root directory that contains at least one BDAV directory. The BDAV directory includes files such as ‘info.bdav’, ‘menu.tidx’, and ‘mark.tidx’, a PLAYLIST subdirectory in which playlist files (*.rpls and *.vpls) are stored, a CLIPINF subdirectory in which clip information files (*.clpi) are stored, and a STREAM subdirectory in which MPEG2-formatted A/V stream clip files (*.m2ts) corresponding to the clip information files are stored. In addition to illustrating the data structure of the optical disk, FIG. 1 represents the areas of the optical disk. For example, the general information file info.bdav is stored in a general information area or areas on the optical disk.

Because the BD-RE data structure and disk format as illustrated in FIG. 1 is well-known and readily available, only a brief overview of the file structure will be provided in this disclosure.

As alluded to above, the STREAM directory includes MPEG2-formatted A/V stream files called clips. The STREAM directory may also include a special type of clip referred to as a bridge-clip A/V stream file. A bridge-clip is used for making seamless connection between two or more presentation intervals selected in the clips, and generally have a small data size compared to the clips.

The CLIPINF directory includes a clip information file associated with each A/V stream file. The clip information file indicates, among other things, the type of A/V stream associated therewith, number of source packets in the A/V stream associated therewith, and timing information of the source packets in the A/V stream associated therewith (e.g., on an arrival time basis (ATC) and/or a system time basis (STC)).

The PLAYLIST directory includes one or more playlist files. The concept of a playlist has been introduced to promote ease of editing/assembling clips for playback. A playlist file is a collection of playing intervals in the clips. Each playing interval is referred to as a playitem. The playlist file, among other things, identifies each playitem forming the playlist, and each playitem, among other things, is a pair of IN-point and OUT-point that point to positions on a time axis of the clip (e.g., ATC or STC basis). Expressed another way, the playlist file identifies playitems, each playitem points to a clip or portion thereof and identifies the clip file associated with the clip.

A playlist directory may include real playlists (*.rpls) and virtual playlists (*.vpls). A real playlist can only use clips and not bridge-clips. Namely, the real playlist is considered as referring to parts of clips, and therefore, conceptually considered equivalent in disk space to the referred to parts of the clips. A virtual playlist can use both clips and bridge-clips, and therefore, the conceptual considerations of a real playlist do not exist with virtual playlists.

The info.bdav file is a general information file that provides general information for managing the reproduction of the A/V stream recorded on the optical disk. More specifically, the info.bdav file includes, among other things, a table of playlists that identifies the files names of the playlist in the PLAYLIST directory of the same BDAV directory.

The menu.tidx, menu.tdt1 and menu.tdt2 files store information related to menu thumbnails. The mark.tidx, mark.tdt1 and mark.tdt2 files store information that relates to mark thumbnails. Because these files are not particularly relevant to the present invention, they will not be discussed further.

The standardization for high-density read-only optical disks such as the Blu-ray ROM (BD-ROM) is still under way. An effective data structure for managing reproduction of video and audio data, especially, multiple reproduction path (multiple angles, multiple parental levels, etc.) video and audio data recorded on the high-density read-only optical disk such as a BD-ROM is not yet available.

### SUMMARY OF THE INVENTION

It is an object of the present invention to provide a recording medium having a data structure for effectively managing reproduction of multiple reproduction path video data recorded thereon, and methods and apparatuses for recording and reproducing the video data on such a recording medium.

A recording medium having a data structure for managing reproduction of multi-path video data in accordance with the present invention comprises: a data area storing multi-path video data; and a navigation information area storing playlists including reproduction information of the multi-path video data, wherein the playlists are created as many as the number of reproduction paths of the multi-path video data.

Another recording medium having a data structure for managing reproduction of multi-path video data in accordance with the present invention comprises: a data area storing multi-path video data; and a navigation information area storing a playlist including reproduction information of the multi-path video data, wherein the playlist includes a plurality of playitems pointing to different video data sections pertaining to different reproduction paths, respectively.

Another recording medium having a data structure for managing reproduction of multi-path video data in accordance with the present invention comprises: a data area storing multi-path video data; and a navigation information area storing playlists including reproduction information of the multi-path video data, wherein the playlists are created as many as the number of path segments constituting the multi-path video data.

In one embodiment, each of the path segments is recorded as a single clip file.

In still one embodiment, the multi-path video data is video data having multiple parental levels.

The present invention further provides apparatuses and methods for recording and reproducing the data structure according to the present invention, and recording and reproducing multi-path video data according to the present invention.

### BRIEF DESCRIPTION OF THE DRAWINGS

The above features and other advantages of the present invention will be more clearly understood from the following detailed description taken in conjunction with the accompanying drawings, in which:

FIG. 1 illustrates the prior art file or data structure of a rewritable optical disk according to the Blu-ray Disc REwritable (BD-RE) standard;

FIG. 2 illustrates an exemplary embodiment of a recording medium file or data structure according to the present invention;

FIG. 3 illustrates an example of a recording medium having the data structure of FIG. 2 stored thereon;

FIG. 4 shows title information related to management of reproduction of video data stream that is recorded on a read-only disk;

FIG. 5 shows a first embodiment of a data structure related to management of reproduction of multiple reproduction path video data stream that is recorded on a read-only disk;

FIG. 6 shows a second embodiment of a data structure related to management of reproduction of multiple reproduction path video data stream that is recorded on a read-only disk;

FIG. 7 shows a third embodiment of a data structure related to management of reproduction of multiple reproduction path video data stream that is recorded on a read-only disk;

FIG. 8 shows a fourth embodiment of a data structure related to management of reproduction of multiple reproduction path video data stream that is recorded on a read-only disk; and

FIG. 9 illustrates a schematic diagram of an embodiment of an optical disk recording and reproducing apparatus according to the present invention.

### DETAILED DESCRIPTION OF THE PREFERRED EMBODIMENTS

In order that the invention may be fully understood, preferred embodiments thereof will now be described with reference to the accompanying drawings.

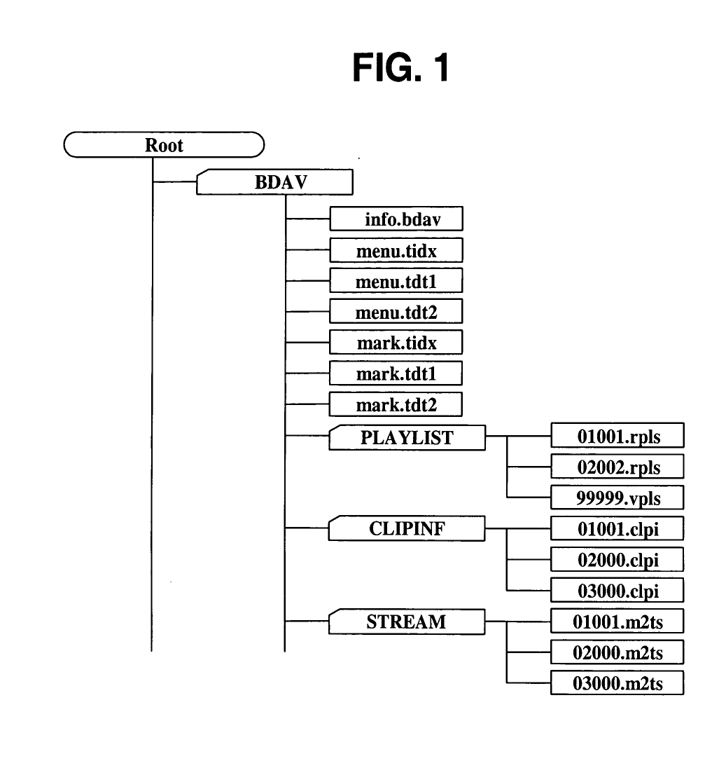

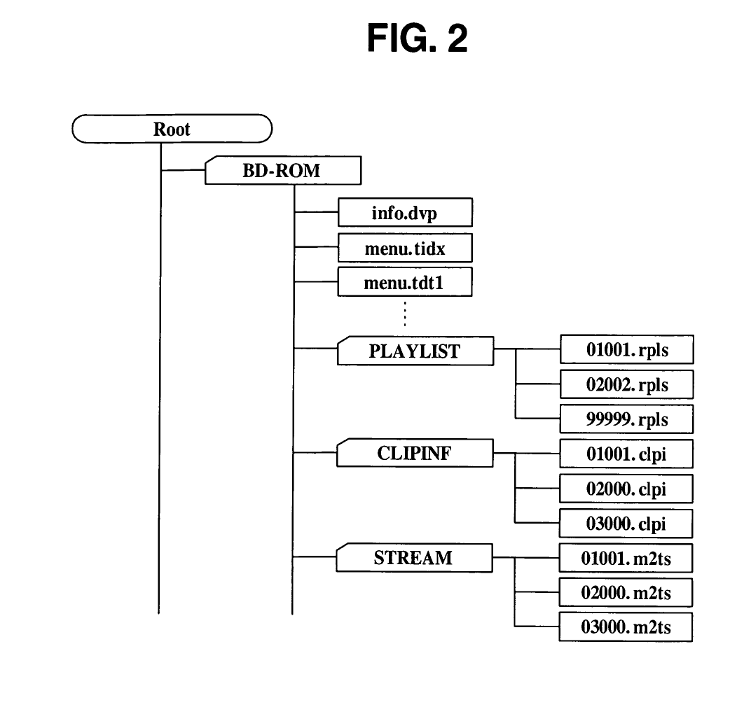

A high-density optical disk, for example, a Blu-Ray ROM (BD-ROM) in accordance with the invention may have a file or data structure for managing reproduction of video and audio data as shown in FIG. 2. Many aspects of the data structure according to the present invention shown in FIG. 2 are similar to that of the BD-RE standard discussed with respect to FIG. 1. As such these aspects will not be described in great detail.

As shown in FIG. 2, the root directory contains at least one BD-ROM directory. The BD-ROM directory includes a general information file info.dvp, menu files menu.tidx, menu.tdt1 among others, a PLAYLIST directory in which playlist files (e.g., real (*.rpls) and virtual (*.vpls)) are stored, a CLIPINF directory in which clip information files (*.clpi) are stored, and a STREAM directory in which MPEG2-formatted A/V stream clip files (*.m2ts), corresponding to the clip information files, are stored.

The STREAM directory includes MPEG2-formatted A/V stream files called clips. The STREAM directory may also include a special type of clip referred to as a bridge-clip A/V stream file. A bridge-clip is used for making seamless connection between two or more presentation intervals selected in the clips, and generally have a small data size compared to the clips. The A/V stream includes source packets of video and audio data. For example, a source packet of video data includes a header and a transport packet. A source packet includes a source packet number, which is generally a sequentially assigned number that serves as an address for accessing the source packet. Transport packets include a packet identifier (PID). The PID identifies the sequence of transport packets to which a transport packet belongs. Each transport packet in the sequence will have the same PID.

The CLIPINF directory includes a clip information file associated with each A/V stream file. The clip information file indicates, among other things, the type of A/V stream associated therewith, sequence information, program information and timing information. The sequence information describes the arrival time basis (ATC) and system time basis (STC) sequences. For example, the sequence information indicates, among other things, the number of sequences, the beginning and ending time information for each sequence, the address of the first source packet in each sequence and the PID of the transport packets in each sequence. A sequence of source packets in which the contents of a program is constant is called a program sequence. The program information indicates, among other things, the number of program sequences, the starting address for each program sequence, and the PID(S) of transport packets in a program sequence.

The timing information is referred to as characteristic point information (CPI). One form of CPI is the entry point (EP) map. The EP map maps a presentation time stamp (e.g., on an arrival time basis (ATC) and/or a system time basis (STC)) to a source packet address (i.e., source packet number).

The PLAYLIST directory includes one or more playlist files. The concept of a playlist has been introduced to promote ease of editing/assembling clips for playback. A playlist file is a collection of playing intervals in the clips. Each playing interval is referred to as a playitem. The playlist file, among other things, identifies each playitem forming the playlist, and each playitem, among other things, is a pair of IN-point and OUT-point that point to positions on a time axis of the clip (e.g., presentation time stamps on an ATC or STC basis). Expressed another way, the playlist file identifies playitems, each playitem points to a clip or portion thereof and identifies the clip information file associated with the clip. The clip information file is used, among other things, to map the playitems to the clip of source packets.

A playlist directory may include real playlists (*.rpls) and virtual playlists (*.vpls). A real playlist can only use clips and not bridge-clips. Namely, the real playlist is considered as referring to parts of clips, and therefore, conceptually considered equivalent in disk space to the referred to parts of the clips. A virtual playlist can use both clips and bridge-clips, and therefore, the conceptual considerations of a real playlist do not exist with virtual playlists.

The info.dvp file is a general information file that rovides general information for managing the reproduction of the A/V streams recorded on the optical disk. More specifically, the info.dvp file includes, among other things, a table of playlists that identifies the file names of the playlists in the PLAYLIST directory.

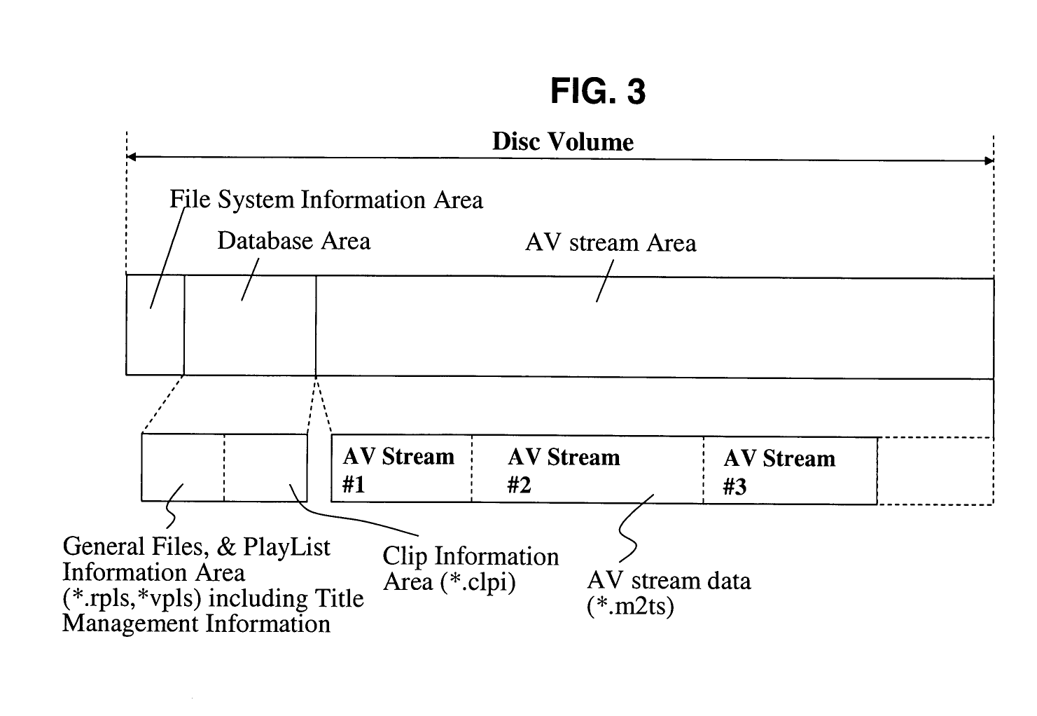

In addition to illustrating the data structure of the recording medium according to an embodiment of the present invention, FIG. 2 represents the areas of the recording medium. For example, the general information file is recorded in one or more general information areas, the playlist directory is recorded in one or more playlist directory areas, each playlist in a playlist directory is recorded in one or more playlist areas of the recording medium, etc. FIG. 3 illustrates an example of a recording medium having the data structure of FIG. 2 stored thereon. As shown, the recording medium includes a file system information area, a data base area and an A/V stream area.

The data base area includes a general information file and playlist and title management information area and a clip information area. The general information file and playlist and title management information area have the general information file recorded in a general information file area thereof, management information of titles, and the PLAYLIST directory and playlist files recorded in a playlist information area thereof. The clip information area has the CLIPINFO directory and associated clip information files recorded therein. The A/V stream area has the A/V streams for the various titles recorded therein.

Video and audio data are typically organized as individual titles; for example, different movies represented by the video and audio data are organized as different titles. Furthermore, a title may be organized into individual chapters in much the same way a book is often organized into chapters.

Because of the large storage capacity of the newer, high-density recording media such as BD-ROM optical disks, various versions of a title or portions of a title may be recorded, and therefore, reproduced from the recording media. For example, video data representing different camera angles may be recorded on the recording medium. Or, an adult version, young adult version and young child version (i.e., different parental control versions) of a title or portions of a title may be recorded on the recording medium. Each version represents a different reproduction path, and the video data in these instances is referred to as multiple reproduction path video data. It will be appreciated that camera angle and parental control versions are but two examples of multiple reproduction path video data, and the present invention is applicable to any type or combination of types of multiple reproduction path video data.

As will be described in detail below with respect to embodiments of the present invention, the data structures according to the present invention comprise navigation information including title management information for managing reproduction of multiple reproduction path video data recorded on the recording medium.

The data structures writing according to the present invention may be applicable to the manufacturing process in case of a read-only disk like BD-ROM.

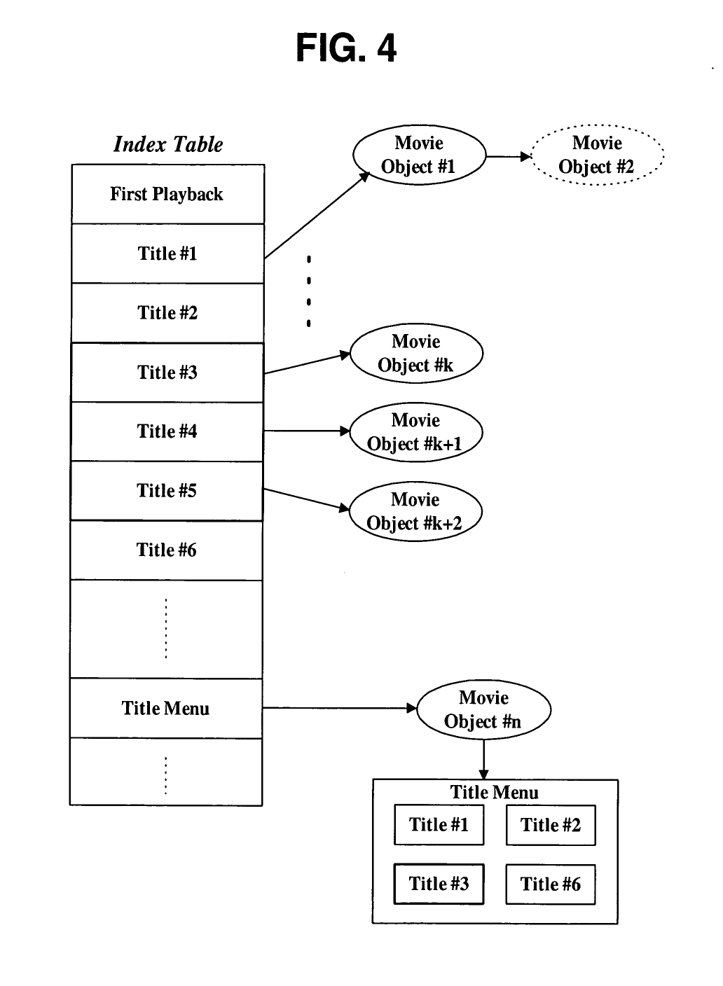

FIG. 4 shows a data structure, namely, index table related to management of multiple reproduction path video data stream that is recorded as A/V clip files on physical data recording area in a read-only disk like BD-ROM.

An index table illustrated in FIG. 4 is one of the title management information. The index table includes first play information, information for each title, and menu information including, e.g., thumbnail information to show descriptive image of each title. Each title information (Title #i) is eventually associated with a multiple reproduction path video data stream recorded as at least one A/V clip files.

Each piece of the title information includes a pointer of movie object related thereto and one title information can be associated with two movie objects or more as well in accordance with embodiments that will be described below. Each movie object is connected to at least one playlist that points to at least one A/V clip file with at least one playitem included therein according to the embodiments of the present invention.

On the other hand, menu data of the title menu included in the index table can be managed as a movie object. This movie object points to a data section containing necessary menu data. The menu data may be included in a video clip file or in a separate file other than a video clip file. When reproduction of titles recorded on a recording medium such as a BD-ROM is requested, a movie object ‘Movie Object #n’ pointed by a title menu is determined first based on the index table, namely, title management information and then corresponding menu data of the determined movie object is reproduced and displayed as a selection menu screen.

Various embodiments to a data structure for managing a multi-path A/V data stream (designated to a single title) recorded as a plurality of clip files are described in detail hereinafter. The below-explained embodiments are on the assumptions that: a multi-path A/V data stream is recorded as four clip files; the first and the fourth clip file have common path, namely, unique path data stream sections, respectively; and the second and the third clip file have mutually different reproduction path, e.g., different parental level data stream sections. However, this is merely an example, and is not limiting on the path structure permitted by the present invention.

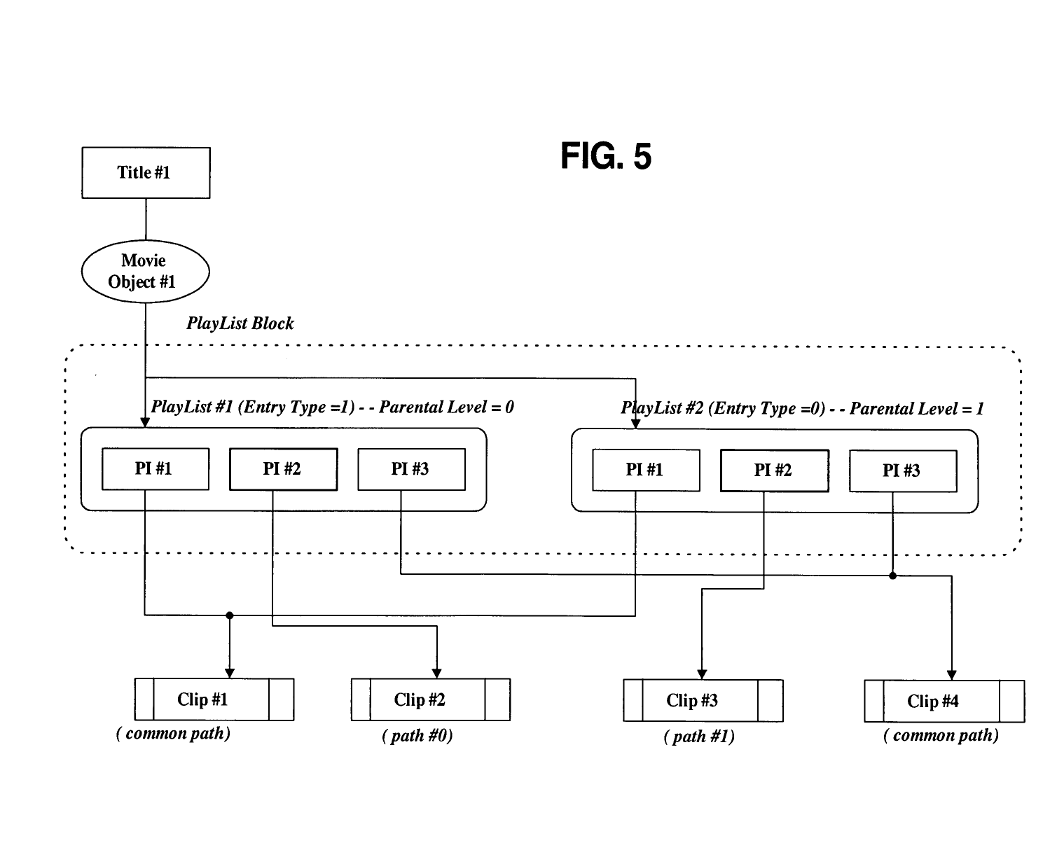

FIG. 5 is a first embodiment of a data structure according to the present invention. In this embodiment, a single playlist is created in association with each reproduction path and a single movie object refers to a plurality of playlists respectively allocated to a plurality of reproduction paths.

The first embodiment of FIG. 5 illustrates a 2-path A/V data stream designated to a single title ‘Title #1’ that is associated with a single movie object ‘Movie Object #1’ through its pointer information. And, the movie object refers two playlists ‘PLs #1 and #2’. The first playlist ‘PL #1’ includes three playitems that are connected to the clip files #1, #2, and #4 respectively while the second ‘PL #2’ includes three playitems pointing to the clip files #1, #3, and #4 respectively. Because the first and the fourth have unique path data stream section individually they are referred twice by two playlists. Because the third and the fourth, individually referred by the two playlists, have data stream sections that are assigned to different reproduction paths, an A/V data stream of a chosen reproduction path can be reproduced through selection of one playlist.

The plurality of playlists for multiple reproduction paths are managed as a playlist block. In addition, path identifying information, e.g., parental level and entry type information are included in each playlist.

The entry type information is indicative of type of a playlist. For example, in the illustrative case shown in FIG. 5, if the first playlist ‘PL #1’ is for basic reproduction path, its entry type information is set to ‘1’. The playlist assigned to basic reproduction path is entry playlist of a title. The entry playlist is default playlist selected in the event that any certain condition or input is not entered for its title. The other playlist ‘PL #2’ of the playlist block has entry type information of ‘0’ which is indicative of non-entry, namely, only a member of playlist block.

The playlist block including an entry playlist with its entry type=1 and at least one non-entry playlist with its entry type=0 is regarded as a single playlist when playlist menu items are displayed on a playlist menu. That is, a single menu item is provided for the two playlists ‘PLs #1 and #2’ when a playlist selection menu is displayed.

When a recording medium including the data structure recorded as FIG. 5 is inserted in a disk reproducing apparatus, it checks whether a plurality of playlists are referred by a movie object of a selected title. If not a single playlist, it requests a user selection for reproduction path, e.g., parental level. If a user selection is not entered for a limited time, the entry playlist ‘PL #1’ is chosen and its referring A/V clip files are reproduced sequentially. If a certain parental level is selected, a playlist assigned to the selected level is reproduced.

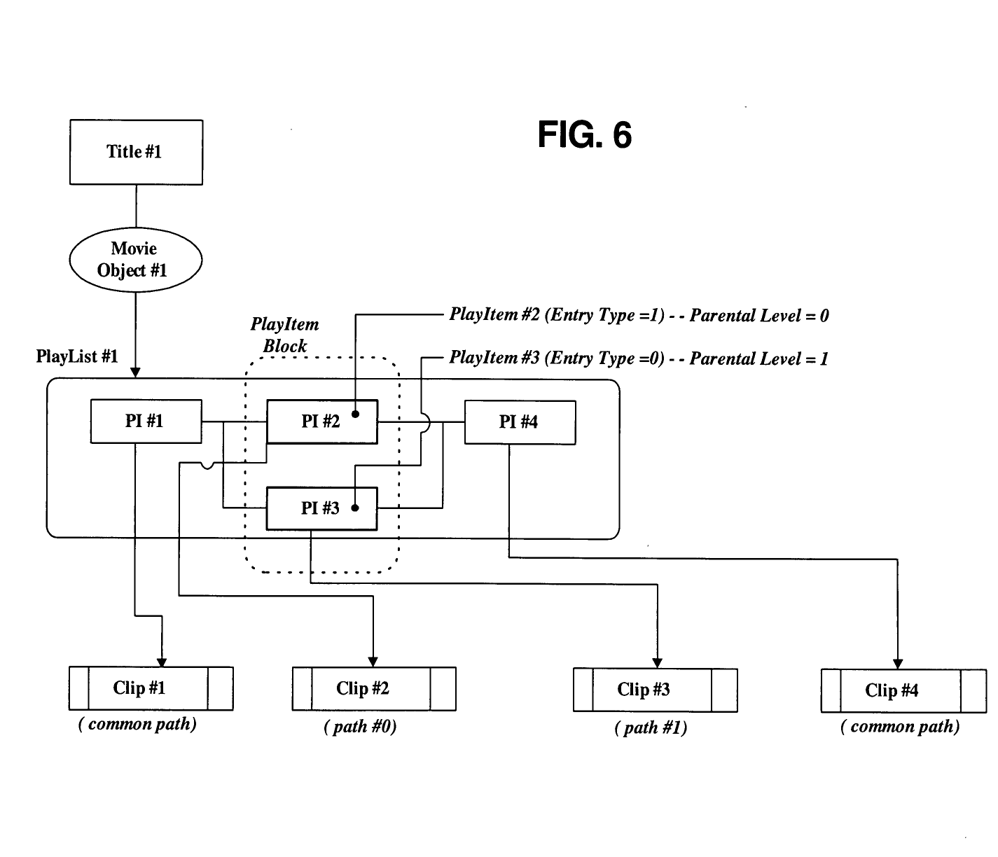

FIG. 6 is a second embodiment of a data structure according to the present invention. In the second embodiment, a single playlist is created in association with all reproduction paths and clip files of different reproduction paths are pointed by different playitems included in the playlist.

In the second embodiment of FIG. 6, a 2-path A/V data stream designated to a single title ‘Title #1’ is eventually associated with a single playlist ‘PL #1’ including four playitems. The first and the fourth playitem point to the unique path clip files #1 and #4 respectively and the second and the third point to the clip files #2 and #3, respectively that are associated with mutually different reproduction paths.

The plurality of playitems related to multiple reproduction paths are managed as a playitem block. In addition, path identifying information, e.g., parental level and entry type information are included in each playitem.

The entry type information is indicative of type of a playitem. For example, in the illustrative case shown in FIG. 6, if the second playitem ‘PI #2’ is for basic reproduction path, its entry type information is set to ‘1’. The playitem assigned to basic reproduction path is entry playitem of the playitem block. The entry playitem is default playitem selected in the event that any certain condition or input is not entered for its playitem block. The other playitem ‘PL #3’ of the playitem block has entry type information of ‘0’ which is indicative of non-entry, namely, only a member of playitem block. Independent playitems, e.g., playitems #1 and #4, not included in the playitem block, have entry type information of ‘1’.

The playitem block including an entry playitem with its entry type=1 and at least one non-entry playitem with its entry type=0 is regarded as a single playitem when playitem jump is conducted. That is, if a jump to next playitem is requested while the clip file #2 pointed by the second playitem ‘PI #2’ is reproduced, the third playitem ‘PI #3’ is skipped and the clip file #4 pointed by the fourth playitem ‘PI #4’ outside the playitem block is reproduced.

When the disk reproducing apparatus reproduces a playlist included in the data structure recorded as FIG. 6, it checks whether a playitem block is included in the playlist. If included, it requests a user selection for reproduction path, e.g., parental level. If a user selection is not entered for a limited time, the entry playitem ‘PI #2’ is chosen after reproducing the clip file #1 pointed by the first playitem ‘PI #1’ and its referring clip file #2 is reproduced. If a certain parental level is selected, a clip file pointed by a playitem in the playitem block assigned to the selected level is reproduced.

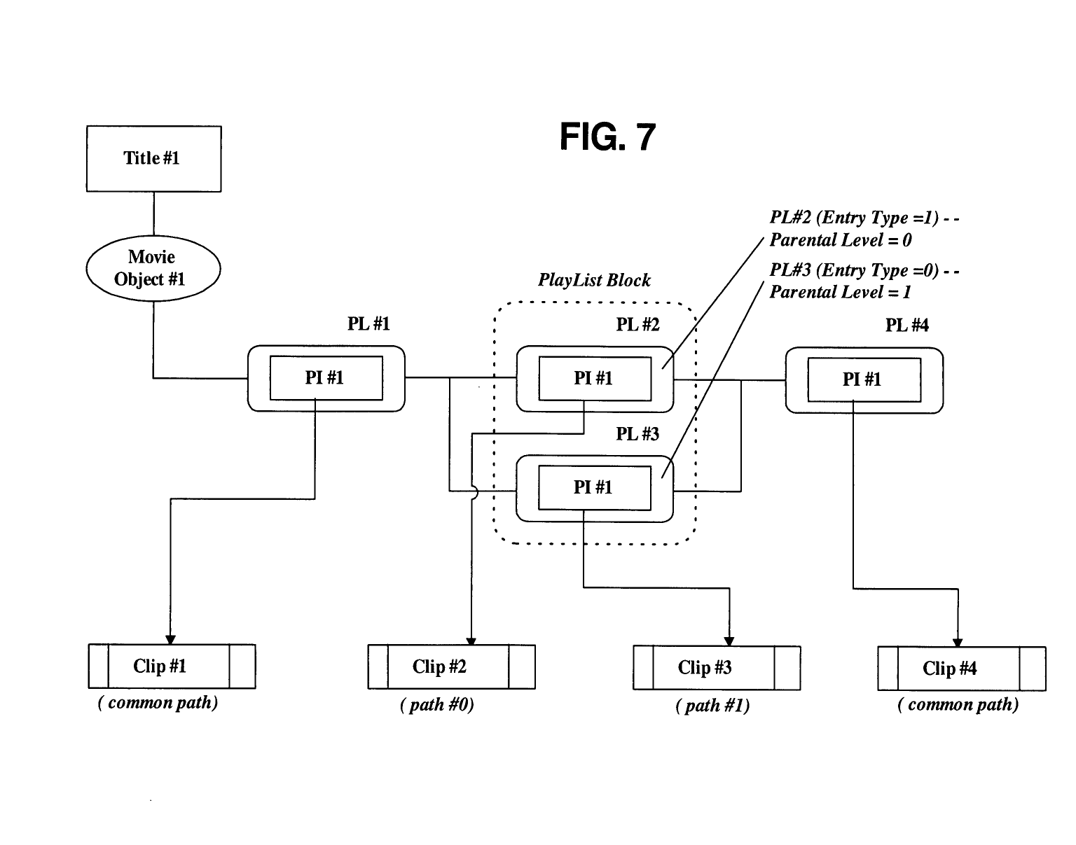

FIG. 7 is a third embodiment of a data structure according to the present invention. In this embodiment, a single playlist is created in association with each path segment and a single movie object refers to all playlists.

The third embodiment of FIG. 7 illustrates a 2-path A/V data stream designated to a single title ‘Title #1’ that is associated with four playlists PLs #1 to #4 for four path segments through a single movie object ‘Movie Object #1’. The first playlist PL #1 and the fourth ‘PL #4’ refer the unique-path clip files #1 and #4 respectively while the second ‘PL #2’ and the third ‘PL #3’ refer the multi-path clip files #2 and #3 respectively.

The playlists ‘PLs #2 and #3’ referring to multiple reproduction paths are managed as a playlist block. In addition, path identifying information, e.g., parental level and entry type information are included in each playlist.

The entry type information is indicative of type of a playlist. For example, in the illustrative case shown in FIG. 7, if the second playlist ‘PL #2’ is for basic reproduction path, its entry type information is set to ‘1’. The playlist assigned to basic reproduction path is entry playlist of a playlist block. The other playlist ‘PL #3’ of the playlist block has entry type information of ‘0’ which is indicative of non-entry, namely, only a member of playlist block. Independent playlists, e.g., playlists #1 and #4, not included in the playlist block, have entry type information of

In the embodiment of FIG. 7, playlists are changed during reproduction of a data stream for a chosen path, therefore, seamless reproduction must be guaranteed at playlist changes. To ensure seamless reproduction, the movie object ‘Movie Object #1’ contains information on pre-commands and/or post-commands to be conducted before and/or after a playlist change.

When the disk reproducing apparatus reproduces a title included in the data structure recorded as FIG. 7, it checks whether a playlist block is included in the chosen title. If included, it requests a user selection for reproduction path, e.g., parental level. If a user selection is not entered for a limited time, the entry playlist ‘PL #2’ is chosen after reproducing the first path segment, namely, the clip file #1 pointed by the first unique-path playlist ‘PL #1’ and its referring clip file #2 is reproduced. If a certain parental level is selected, a clip file pointed by a playlist in the playlist block assigned to the selected level is reproduced after reproducing the clip file #1 pointed by the first unique-path playlist ‘PL #1’.

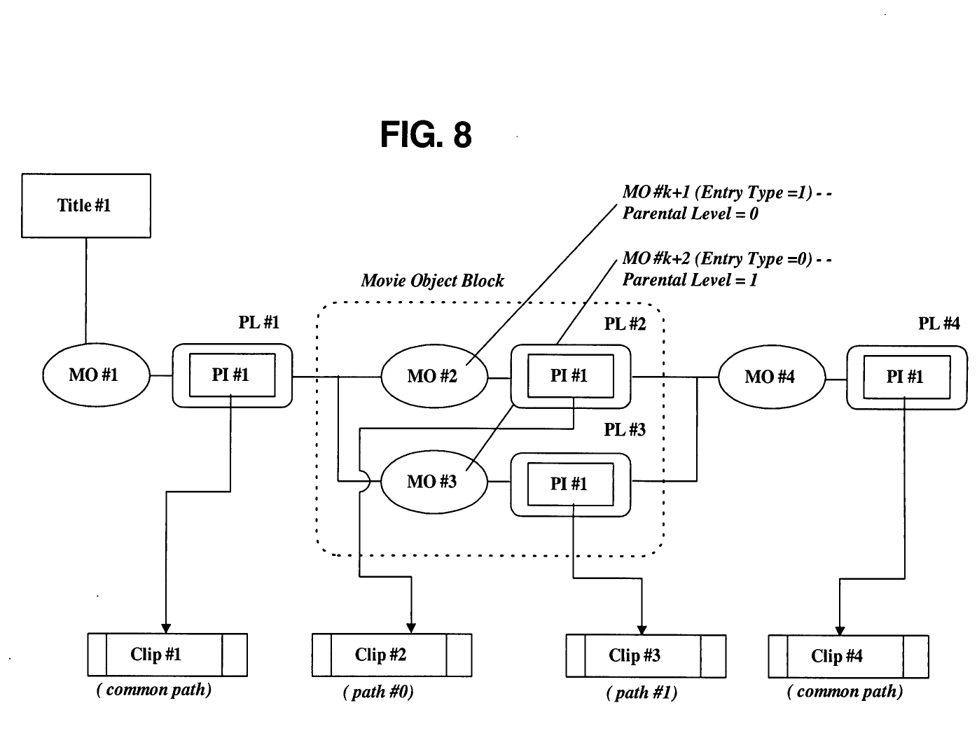

FIG. 8 is a fourth embodiment of a data structure according to the present invention. In this embodiment, a single playlist is created in association with each path segment and a single movie object is created to refer to each playlist.

The fourth embodiment of FIG. 8 illustrates a 2-path A/V data stream designated to a single title ‘Title #1’ that is associated with four playlists PLs #1 to #4 through four movie objects ‘Movie Objects #1 to #4’. The first playlist PL #1 and the fourth ‘PL #4’ refer the unique-path clip files #1 and #4 respectively while the second ‘PL #2’ and the third ‘PL #3’ refer the multi-path clip files #2 and #3 respectively.

The movie objects ‘MOs #2 and #3’ and the playlists ‘PLs #2 and #3’ referring to multiple reproduction paths are managed as a movie object block. In addition, path identifying information, e.g., parental level and entry type information are included in each movie object.

The entry type information is indicative of type of a movie object. For example, in the illustrative case shown in FIG. 8, if the second movie object ‘MO #2’ is for basic reproduction path, its entry type information is set to ‘1’. The movie object assigned to basic reproduction path is entry movie object of a movie object block. The other movie object ‘MO #3’ of the object block has entry type information of ‘0’ which is indicative of non-entry, namely, only a member of movie object block. Independent movie objects, e.g., movie objects #1 and #4, not pertaining to the object block, have entry type information of ‘1’.

In the embodiment of FIG. 8, playlists are changed during reproduction of a data stream for a chosen path, therefore, seamless reproduction must be guaranteed at playlist changes as in the third embodiment of FIG. 7. To ensure seamless reproduction, each movie object ‘MO #1, #2, #3, or #4’ contains information on pre-commands and/or post-commands to be conducted before and/or after a corresponding playlist is reproduced.

When the disk reproducing apparatus reproduces a title included in the data structure recorded as FIG. 8, it checks whether a movie object block is included in the chosen title. If included, it requests a user selection for reproduction path, e.g., parental level. If a user selection is not entered for a limited time, the entry movie object ‘MO #2’ is chosen after reproducing the clip file #1 associated with the first unique-path movie object ‘MO #1’ and its linking clip file #2 is reproduced. If a certain parental level is selected, a clip file associated with a movie object in the movie object block assigned to the selected level is reproduced after reproducing the clip file #1 associated with the first unique-path movie object ‘MO #1’.

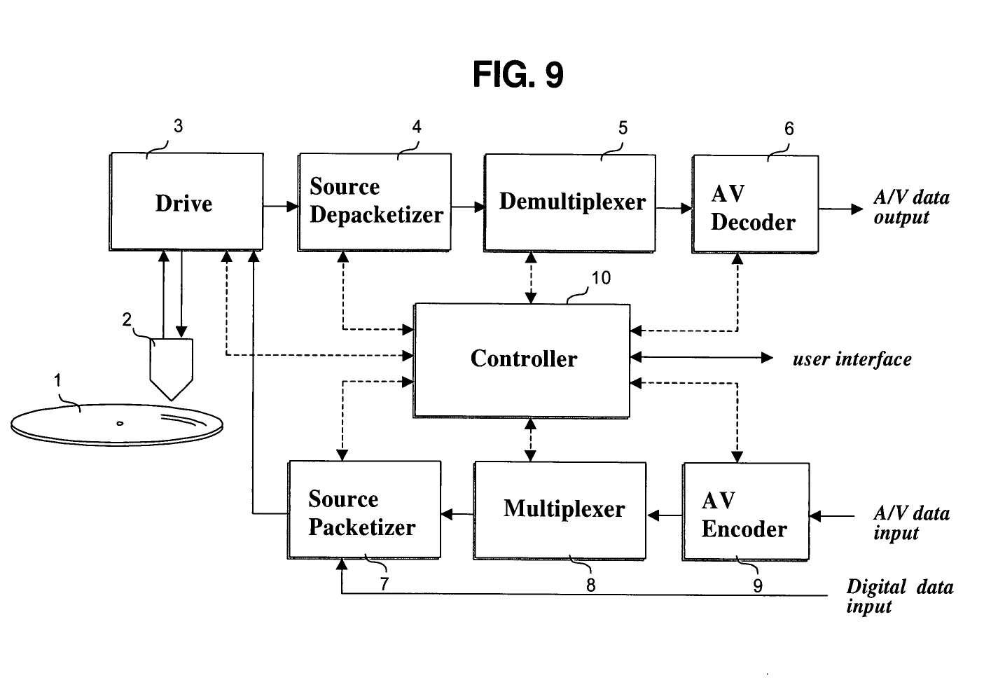

FIG. 9 illustrates a schematic diagram of an embodiment of an optical disk recording and reproducing apparatus according to the present invention. As shown, an AV encoder 9 receives and encodes audio and video data. The AV encoder 9 outputs the encoded audio and video data along with coding information and stream attribute information. A multiplexer 8 multiplexes the encoded audio and video data based on the coding information and stream attribute information to create, for example, an MPEG-2 transport stream. A source packetizer 7 packetizes the transport packets from the multiplexer 8 into source packets in accordance with the audio/video format of the optical disk. As shown in FIG. 9, the operations of the AV encoder 9, the multiplexer 8 and the source packetizer 7 are controlled by a controller 10. The controller 10 receives user input on the recording operation, and provides control information to AV encoder 9, multiplexer 8 and the source packetizer 7. For example, the controller 10 instructs the AV encoder 9 on the type of encoding to perform, instructs the multiplexer 8 on the transport stream to create, and instructs the source packetizer 7 on the source packet format. The controller 10 further controls a drive 3 to record the output from the source packetizer 7 on the optical disk.

The controller 10 also creates the navigation information, that is explained above, for managing reproduction of the audio/video data being recorded on the optical disk. For example, based on information received via the user interface (e.g., instruction set saved on disk, provided over an intranet or internet by a computer system, etc.) the controller 10 controls the drive 3 to record the data structure of FIGS. 2 to 4 and FIG. 5, 6, 7 or 8 on the optical disk.

In the process of reproduction, the controller 10 controls the drive 3 to reproduce this data structure from the optical disk. Based on the information contained therein, as well as user input received over the user interface (e.g., control buttons on the recording and reproducing apparatus or a remote associated with the apparatus), the controller 10 controls the drive 3 to reproduce the audio/video source packets from the optical disk. For example, the user input may specify a reproduction path, namely, a parental level or a title to reproduce. This user input may be specified, for example, via a menu based graphical user interface preprogrammed into the controller 10. Using the user input and the aforementioned navigation information reproduced from the optical disk, the controller 10 controls the reproduction of playitems, a playlist or playlists, or a movie object or movie objects associated with the specified path, namely, parental level.

For example, if a title is chosen from a recording medium including the data structure, the controller 10 examines the navigation information for the chosen title, and checks whether the title has multiple reproduction paths. If multiple paths, the controller 10 provides, e.g., a parental level selection menu for a user. If a parental level is selected, the controller 10 determines playitems, a playlist, playlists, or movie objects associated with the selected parental level, searches for clip files associated with the determined ones, and reproduces the them sequentially.

The reproduced source packets are received by a source depacketizer 4 and converted into a data stream (e.g., an MPEG-2 transport packet stream). A demultiplexer 5 demultiplexes the data stream into encoded video and audio data. An AV decoder 6 decodes the encoded video and audio data to produce the original audio and video data that was fed to the AV encoder 9. During reproduction, the controller 10 controls the operation of the source depacketizer 4, demultiplexer 5 and AV decoder 6. The controller 10 receives user input on the reproducing operation, and provides control information to AV decoder 6, demultiplexer 5 and the source packetizer 4. For example, the controller 10 instructs the AV decoder 9 on the type of decoding to perform, instructs the demultiplexer 5 on the transport stream to demultiplex, and instructs the source depacketizer 4 on the source packet format.

While FIG. 9 has been described as a recording and reproducing apparatus, it will be understood that only a recording or only a reproducing apparatus may be provided using those portions of FIG. 9 providing the recording or reproducing function.

The present invention, disclosed with respect to a limited number of embodiments, provides a greater level of flexibility in the multi-path, e.g., multiple parental level reproduction of video data than previously available.

While the invention has been disclosed with respect to a limited number of embodiments, those skilled in the art, having the benefit of this disclosure, will appreciated numerous modifications and variations therefrom. It is intended that all such modifications and variations fall within the spirit and scope of the invention.

What is claimed is:

1. A recording medium having a data structure for managing reproduction of multi-path video data recorded on the recording medium, comprising:
a data area storing the multi-path video data; and
a navigation information area storing playlists including reproduction information of the multi-path video data,
wherein the playlists are created as many as the number of reproduction paths of the multi-path video data.

2. The recording medium of claim 1, wherein each of the playlists is associated with all of data stream clip files pertaining to one path of the multiple reproduction paths.

3. The recording medium of claim 1, wherein each of the playlists has type information to identify whether it is entry playlist or not.

4. The recording medium of claim 1, wherein the playlists include at least one playitem individually, the playitems included in the different playlists refer a same clip file containing common path video data section of the multi-path video data.

5. A recording medium having a data structure for managing reproduction of multi-path video data recorded on the recording medium, comprising:
a data area storing the multi-path video data; and
a navigation information area storing a playlist including reproduction information of the multi-path video data,
wherein the playlist includes a plurality of playitems pointing to different video data sections pertaining to different reproduction paths, respectively.

6. The recording medium of claim 5, wherein the playlist further includes at least one playitem pointing to a clip file containing common path video data section of the multi-path video data.

7. The recording medium of claim 5, wherein each of the playitems has type information to identify whether it is entry playitem or not.

8. A recording medium having a data structure for managing reproduction of multi-path video data recorded on the recording medium, comprising:
a data area storing the multi-path video data; and
a navigation information area storing playlists including reproduction information of the multi-path video data,
wherein the playlists are created as many as the number of path segments constituting the multi-path video data.

9. The recording medium of claim 8, wherein each of the path segments is recorded in a single clip file.

10. The recording medium of claim 8, wherein each of the playlists has type information to identify whether it is entry playlist or not.

11. The recording medium of claim 8, wherein the navigation information area further comprises object information including pre-commands and/or post-commands to be conducted before and/or after each playlist is reproduced.

12. The recording medium of claim 11, wherein single object information is created for the multi-path video data.

13. The recording medium of claim 11, wherein the object information is created for each of the playlists.

14. The recording medium of claim 13, wherein each object information has type information to identify whether it is entry object or not.

15. A method for recording a data structure for managing reproduction of multi-path video data on a recording medium, comprising:
recording the multi-path video data in a data area on the recording medium; and
recording a plurality of playlists including reproduction information of the multi-path video data in a navigation information area on the recording medium,
wherein the playlists are created as many as the number of reproduction paths of the multi-path video data.

16. A method for recording a data structure for managing reproduction of multi-path video data on a recording medium, comprising:
recording the multi-path video data in a data area on the recording medium; and
recording a playlist including reproduction information of the multi-path video data in a navigation information area on the recording medium,
wherein the playlist includes a plurality of playitems pointing to different video data sections pertaining to different reproduction paths, respectively.

17. A method for recording a data structure for managing reproduction of multi-path video data on a recording medium, comprising:
recording the multi-path video data in a data area on the recording medium; and
recording playlists including reproduction information of the multi-path video data in a navigation information area on the recording medium,
wherein the playlists are created as many as the number of path segments constituting the multi-path video data.

18. An apparatus for recording a data structure for managing reproduction of multi-path video data on a recording medium, comprising:
a drive for driving an optical recording means that records data on the recording medium;
an encoder for encoding the multi-path video data; and
a controller for controlling the drive to record the encoded multi-path video data in a data area on the recording medium and a plurality of playlists including reproduction information of the multi-path video data in a navigation information area on the recording medium, such that the playlists are created as many as the number of reproduction paths of the multi-path video data.

19. An apparatus for recording a data structure for managing reproduction of multi-path video data on a recording medium, comprising:
a drive for driving an optical recording means that records data on the recording medium;
an encoder for encoding the multi-path video data; and
a controller for controlling the drive to record the encoded multi-path video data in a data area on the recording medium and a playlist including reproduction information of the multi-path video data in a navigation information area on the recording medium, such that the playlist includes a plurality of playitems pointing to different video data sections pertaining to different reproduction paths, respectively.

20. An apparatus for recording a data structure for managing reproduction of multi-path video data on a recording medium, comprising:
a drive for driving an optical recording means that records data on the recording medium;
an encoder for encoding the multi-path video data; and
a controller for controlling the drive to record the encoded multi-path video data in a data area on the recording medium and a plurality of playlists including reproduction information of the multi-path video data in a navigation information area on the recording medium, such that the playlists are created as many as the number of path segments constituting the multi-path video data.

21. A method for reproducing a data structure for managing reproduction of multi-path video data recorded on a recording medium, comprising:
reproducing at least one playlist including reproduction information of the multi-path video data from a navigation information area on the recording medium;
selecting one playlist or one playitem among playitems included in the playlist based on a chosen reproduction path; and
reproducing full or a part of one path of the multi-path video data indicated by the selected playlist or playitem.

22. An apparatus for reproducing a data structure for managing reproduction of multi-path video data recorded on a recording medium, comprising:
a drive for driving an optical reproducing device to reproduce data recorded on the recording medium;
a decoder for presenting the reproduced data; and
a controller for controlling the drive to reproduce at least one playlist including reproduction information of the multi-path video data from a navigation information area on the recording medium, selecting one playlist or one playitem among playitems included in the playlist based on a chosen reproduction path, and controlling the drive to reproduce full or a part of one path of the multi-path video data indicated by the selected playlist or playitem.
